(19) United States
(12) Patent Application Publication
(10) Pub. No.: US 2019/0372937 A1
(43) Pub. Date: Dec. 5, 2019

(54) SYSTEMS AND METHODS FOR SPLIT NETWORK TUNNELING BASED ON TRAFFIC INSPECTION

(71) Applicant: Symantec Corporation, Mountain View, CA (US)

(72) Inventors: Qu Bo Song, Singapore (SG); Shaun Aimoto, North York (CA); Weiliang Li, Singapore (SG); Joseph Chen, Culver City, CA (US)

(21) Appl. No.: 15/994,951

(22) Filed: May 31, 2018

(51) Int. Cl. H04L 29/06; H04L 12/46

(52) U.S. Cl. CPC H04L 63/0272; H04L 63/029; H04L 61/1511; H04L 12/4633; H04L 63/0227; H04L 63/1408

(57) ABSTRACT

The disclosed computer-implemented method for split network tunneling based on traffic inspection may include a computing device directing network traffic to a network client of the computing device. The network client may perform an inspection of the network traffic. The network traffic may be categorized based on the inspection. In response to categorizing the network traffic, a security action may be performed to protect the computing device from computer malware. Various other methods, systems, and computer-readable media are also disclosed.

### BACKGROUND

Public wireless networks may pose special security threats to network users and administrators. For example, public wireless networks may enable any person or guest to access these networks without performing any security check or identity authentication. Accordingly, attackers and malicious users may readily obtain access to these wireless networks and carry out attacks on corresponding computing resources. For example, public wireless networks may enable any user to readily sniff, obtain, read, or parse network communications between other users and a shared access point.

Some users may utilize a virtual private network (VPN) to reduce the security threats when utilizing public wireless networks. A VPN may enable users to send and receive data across public networks by extending a private network across the public network, as if the computing devices were directly connected to the private network. Applications that utilize a VPN may benefit from the security of the private network. A VPN may also allow users to securely access an internal intranet, which may include protected resources only accessible through the intranet, while located outside the office. Unfortunately, only some of the network traffic of a computing device may be directed to the VPN, which may result in network traffic that circumvents any security checks or inspection provided by the VPN.

In some traditional systems, computing devices may utilize split tunneling techniques to access dissimilar security domains, like a public network (e.g., the Internet) and a LAN or WAN, at the same time, using the same or different network connections. Split tunneling may utilize a routing table of the operating system to split the traffic based on its destination IP address before the traffic reaches the VPN client. Split tunneling may provide benefits, such as conservation of bandwidth of the VPN server as irrelevant traffic is not passed through the VPN server. Another benefit includes providing users in a third-party network environment who wish to access both private resource behind a VPN server and resources in the third-party network the ability to access both, without having to constantly connect and disconnect the VPN client.

Split tunneling may provide several disadvantages. For example, traffic bypassing the VPN will also bypass any traffic inspection provided by the VPN infrastructure. The instant disclosure, therefore, identifies and addresses a need for systems and methods for split network tunneling based on traffic inspection.

### SUMMARY

As will be described in greater detail below, the instant disclosure describes various systems and methods for split network tunneling based on traffic inspection.

In one example, a method for split network tunneling based on traffic inspection may include (i) directing, by the computing device, network traffic to a network client of the computing device, (ii) performing, by the network client, an inspection of the network traffic, (iii) categorizing the network traffic based on the inspection, and (iv) in response to categorizing the network traffic, performing a security action to protect the computing device from computer malware.

In some examples, the step of performing the inspection of the network traffic may include determining that the network traffic is a domain name system (DNS) request. The method may further include (i) parsing the network traffic, (ii) extracting a domain name from the network traffic, (iii) determining a reputation of the domain name, and (iv) in response to determining the reputation of the domain name, performing the security action, wherein the security action comprises one of blocking access to a domain of the domain name and allowing access to the domain of the domain name.

In some examples, the step of performing the inspection of the network traffic may include determining that the network traffic is a hypertext transfer protocol (HTTP) request. The method may further include (i) parsing the network traffic, (ii) determining that the HTTP request is for a protected resource of a remote server, and (iii) performing the security action, wherein the security action comprises transmitting the network traffic over a secure tunnel to the remote server.

In some examples, the security action may be one of (i) blocking transmission of the network traffic, (ii) transmitting the network traffic directly to a destination host, or (iii) transmitting the network traffic through a secure tunnel connection to a remote server. In some examples, the method may include establishing secure channel to a designated server and transmitting a portion of the network traffic to the designated server using the secure channel. In some embodiments, the secure tunnel connection may be one of (i) a transport layer security (TLS) tunnel, (ii) a datagram TLS (DTLS) tunnel, (iii) an Internet Protocol Security (IPsec) tunnel, and (iv) an OpenVPN tunnel.

In some examples, the step of transmitting the network traffic directly to the destination host may include (i) transmitting a payload of a packet of the network traffic directly to the destination host, (ii) receiving a response from the destination host, (iii) embedding the response in a response packet, and (iv) transmitting the response packet to the network client.

In some examples, the method may include (i) logging the network traffic and the security action, (ii) correlating the network traffic and the security action, and (iii) generating a policy for the inspection of the network traffic based at least in part on correlations of the network traffic and the security action.

In one example, a system for split network tunneling based on traffic inspection may include a computing device comprising at least one physical processor; and physical memory comprising computer-executable instructions that, when executed by the at least one physical processor, cause the computing device to (i) direct network traffic to a network client of the computing device, (ii) perform, by the network client, an inspection of the network traffic, (iii) categorize the network traffic based on the inspection, and (iv) in response to categorizing the network traffic, perform a security action to protect the computing device from computer malware.

In some examples, to perform the inspection of the network traffic, the computer-executable instructions may further cause the one or more computing devices to determine that the network traffic is a domain name system (DNS) request. The computer-executable instructions may further cause the computing device to (i) parse the network traffic, (ii) extract a domain name from the network traffic, (iii) determine a reputation of the domain name, and (iv) in response to a determination of the reputation of the domain name, perform the security action, wherein the security action comprises one of blocking access to a domain of the domain name and allowing access to the domain of the domain name.

In some examples, to perform the inspection of the network traffic, the computer-executable instructions may further cause the computing device to determine that the network traffic is a hypertext transfer protocol (HTTP) request. The computer-executable instructions may further cause the one or more computing devices to (i) parse the network traffic, (ii) determine that the HTTP request is for a protected resource of a remote server, and (iii) perform the security action, wherein the security action comprises transmitting the network traffic over a secure tunnel to the remote server.

In some examples, the security action may be one of (i) blocking transmission of the network traffic, (ii) transmitting the network traffic directly to a destination host, or (iii) transmitting the network traffic through a secure tunnel connection to a remote server. In some embodiments, the secure tunnel connection may be one of (i) a transport layer security (TLS) tunnel, (ii) a datagram TLS (DTLS) tunnel, (iii) an Internet Protocol Security (IPsec) tunnel, and (iv) an OpenVPN tunnel.

In some examples, to transmit the network traffic directly to a destination host, the computer-executable instructions may further cause the computing device to (i) transmit a payload of a packet of the network traffic directly to the destination host, (ii) receive a response from the destination host, (iii) embed the response in a response packet, and (iv) transmit the response packet to the network client.

In some examples, the computer-executable instructions may further cause the one or more computing devices to (i) log the network traffic and the security action, (ii) correlate the network traffic and the security action, and (iii) generate a policy for the inspection of the network traffic based at least in part on correlations of the network traffic and the security action.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) direct network traffic to a network client of the computing device, (ii) perform, by the network client, an inspection of the network traffic, (iii) categorize the network traffic based on the inspection, and (iv) in response to categorizing the network traffic, perform a security action to protect the computing device from computer malware.

In some examples, the security action may cause the computing device to (i) block transmission of the network traffic, (ii) transmit the network traffic directly to a destination host, and (iii) transmit the network traffic through a secure tunnel connection to a remote server.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for split network tunneling based on traffic inspection.

FIG. 2 is a block diagram of an additional example system for split network tunneling based on traffic inspection.

FIG. 3 is a flow diagram of an example method for split network tunneling based on traffic inspection.

FIG. 4 is a block diagram of an example architecture 400 for split tunneling on a computing device.

FIG. 5 is a block diagram of an example architecture for split network tunneling based on traffic inspection.

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for split network tunneling based on traffic inspection.

As will be explained in greater detail below, by directing network traffic to a network client of a computing device, performing an inspection of the network traffic by the network client, and categorizing the network traffic based on the inspection, the systems and methods described herein may be able to perform a security action to protect the computing device from computer malware on network traffic which may have bypassed such security checks in existing split tunneling solutions.

The systems and methods described herein are directed to providing at least one secure channel and at least one direct channel for network traffic transmission within a network client solution, enabling a network client to make determinations whether to transfer traffic through a secure tunnel connection or directly send the traffic to a destination host without utilizing a third-party server. The network client may provide multiple secure channels and multiple direct channels for a computing device. In some examples, the secure channels may be middlebox channels. A middlebox may be a component that scans for malware along an encrypted channel. Determinations regarding traffic routing may be made based on dynamic policies and/or traffic inspection results within the network security solutions provided by the network client. Thus, the network client may provide seamless network traffic transfer between a secure tunnel channel and direct channel, based on traffic inspection results and a set of dynamic policies.

In some examples, the systems and methods described herein may be directed to a network client that comprises multiple components. An inspection component of the network client may receive device traffic redirected by a computing device, packet inspection of the traffic, and traffic transmission determinations based on the packet inspection and dynamic security policies. The network client may be an implementation of a VPN interface provided by system software development kits (SDKs) and may include protocol parsers, which may parse data from different layers of a network packet of the device traffic. The parsed data may be used to determine a security action to protect the computing device from computer malware. In some embodiments, based at least in part on the parsed data and one or more dynamic policies, the inspection component of the network client may determine to block the traffic from transmission, send the traffic directly to a destination host, and/or send the traffic through a secure tunnel connection to a remote server.

In one example, the inspection component of the network client may determine that the network traffic includes a DNS request. A DNS parser of the network client may be able to extract the domain name from the packet and retrieve reputation data associated with the domain name. Based on the reputation data retrieved, the network client may determine to block or allow access to that domain.

In another example, the device traffic may include a Hypertext Transfer Protocol (HTTP) request targeting a specific corporate-owned resource. The inspection component of the network client may, based at least in part on one or more dynamic policies, determine to transmit the traffic over a secure tunnel to a remote corporate server associated with the corporate-owned resource, such as a corporate VPN server.

In another example, the inspection component may determine that the traffic includes streaming video content. The inspection component of the network client may determine to transmit the device traffic directly to a destination host designated in the device traffic.

Additionally, a direct transmission component of the network client may directly transmit device traffic to a destination host, without utilizing a third-party server or first transmitting the traffic to a remote server, such as a remote VPN server. For example, the direct transmission component of the network client may directly transmit to a destination host the payload of an Internet Protocol (IP) packet received from the inspection component. When the direct transmission component receives the response from the destination host, the direct transmission component may embed the response within an IP packet and transmit the response to the inspection component of the network client. The direct transmission component may manage multiple direct connections to different destination hosts, based on the network traffic inspected.

In some examples, a secure transmission component of the network client may provide secure tunnel connections, such as secure VPN tunnel connections, for transmitting device traffic. The secure transmission component may encrypt and/or encapsulate the device traffic in accordance with a secure protocol negotiation with a remote server, such as a remote VPN server, and transmit the traffic to the remote server accordingly. In some embodiments, the secure transmission component may be a transport layer security (TLS) tunnel, a datagram TLS (DTLS) tunnel, an Internet Protocol Security (IPsec) tunnel, or other open protocols (e.g., OpenVPN). The secure transmission component of the network client may receive an IP packet from the inspection component, encrypt and/or encapsulate the IP packet with a designated security protocol and transmit the IP packet to the remote server over the secure tunnel connection. The secure transmission component may receive a response from the remote server, decrypt and/or decapsulate the response to obtain a response IP packet, and transmit the response IP packet to the inspection component of the network client. The secure transmission component may manage multiple secure connections to different remote servers, based on the network traffic inspected. Accordingly, the different components of the network client may inspect and shape device traffic and manage the device traffic utilizing split tunneling.

In addition, the systems and methods described herein may improve the functioning of a computing device by providing a consolidated network client that provides traffic inspection, direct transmission of traffic over one or more channels to one or more destination hosts, and secure transmission of traffic over one or more secure tunnels to a remote server. Providing a consolidated network solution for split network tunneling enables traffic inspection of all network traffic for a computing device while providing the benefits of split tunneling device traffic, namely providing direct internet access or secure connections based on user needs or dynamic policies. The network client may also ensure compliance with certain regulations. For example, content streaming services may want to ban tunneled access to resources under geo-protected copyright. A consolidated network client may enable inspection of traffic and application of security checks by the network client then direct Internet access for such resources.

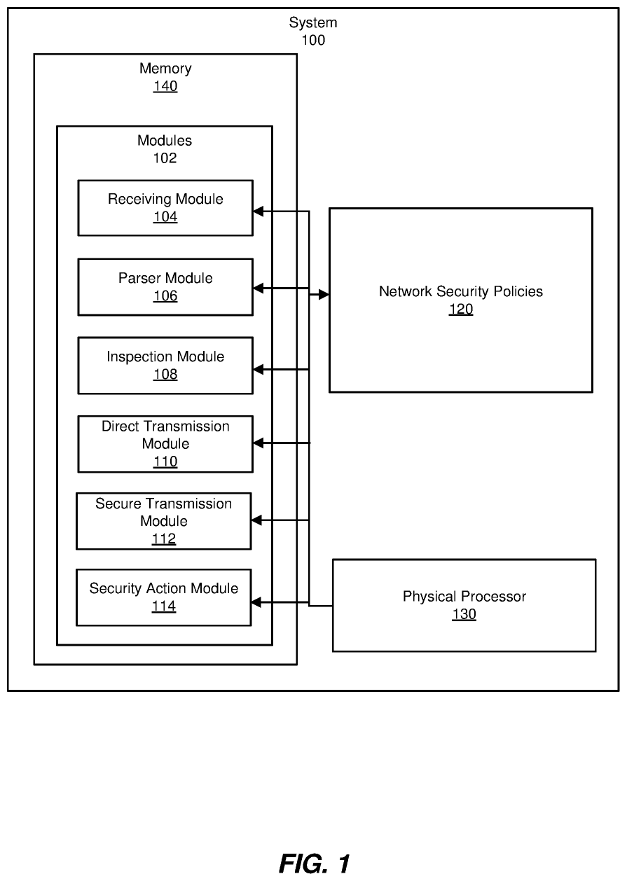

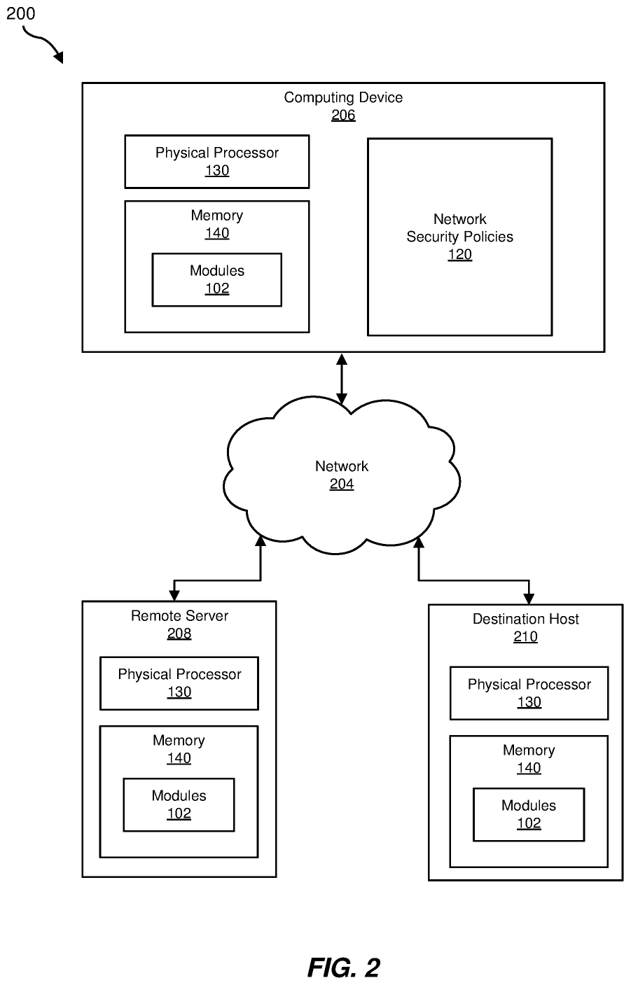

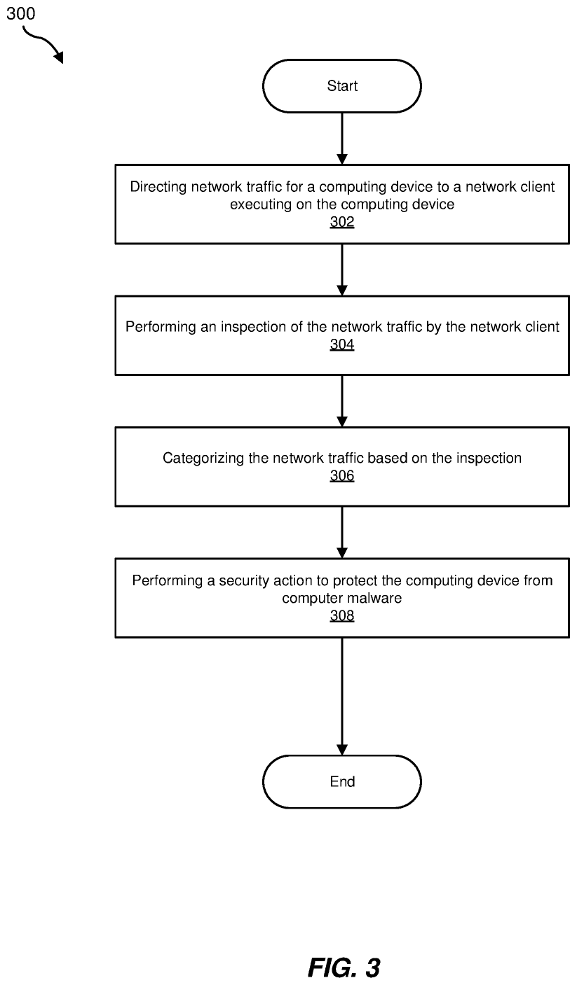

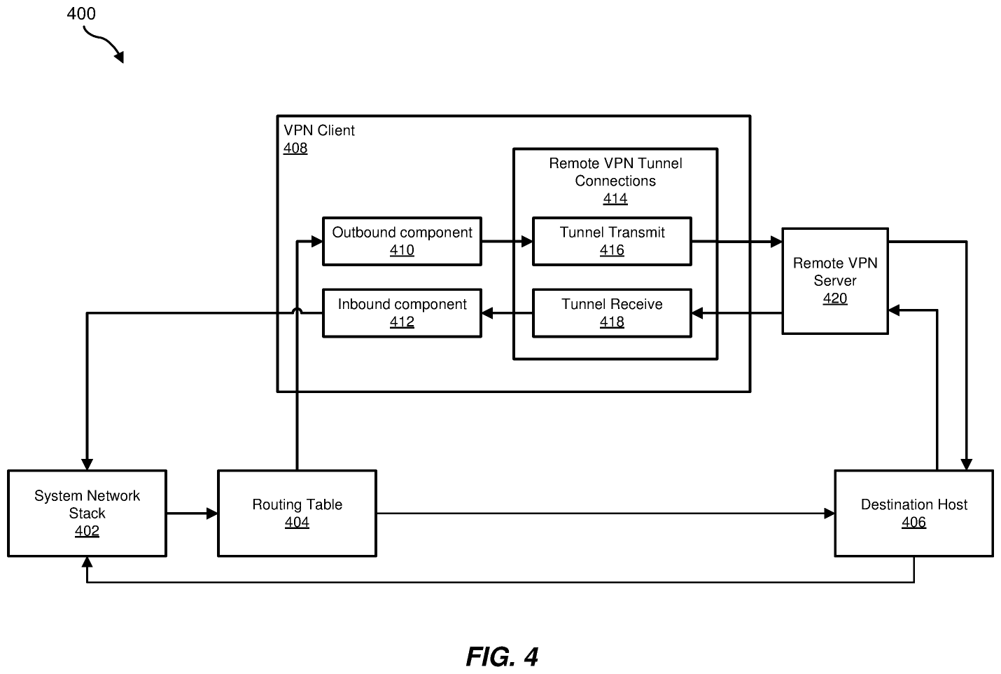

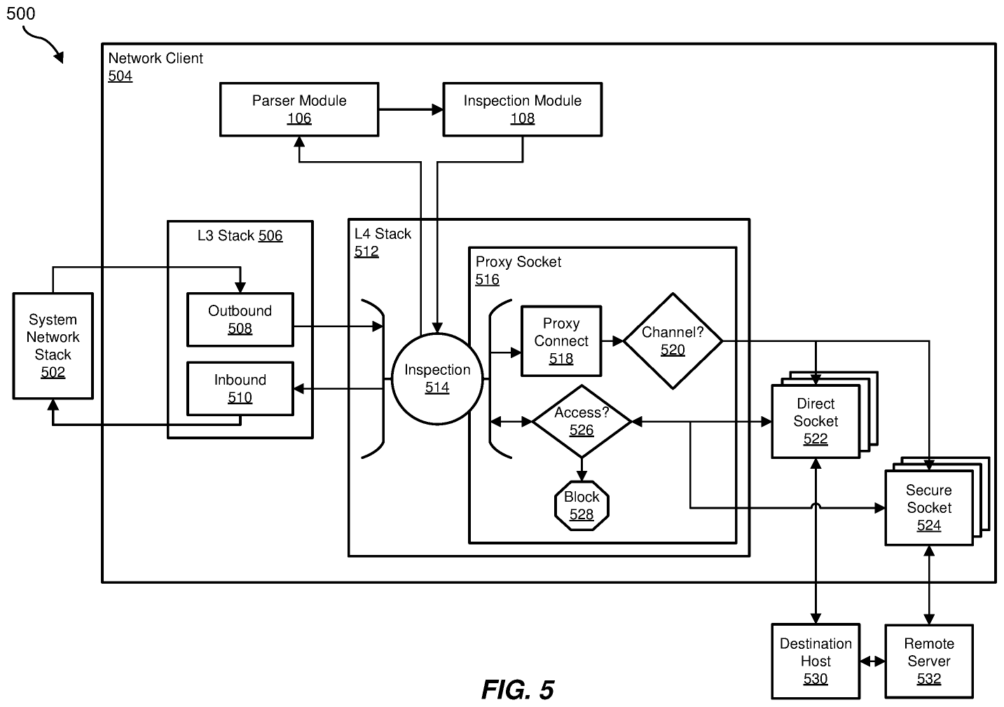

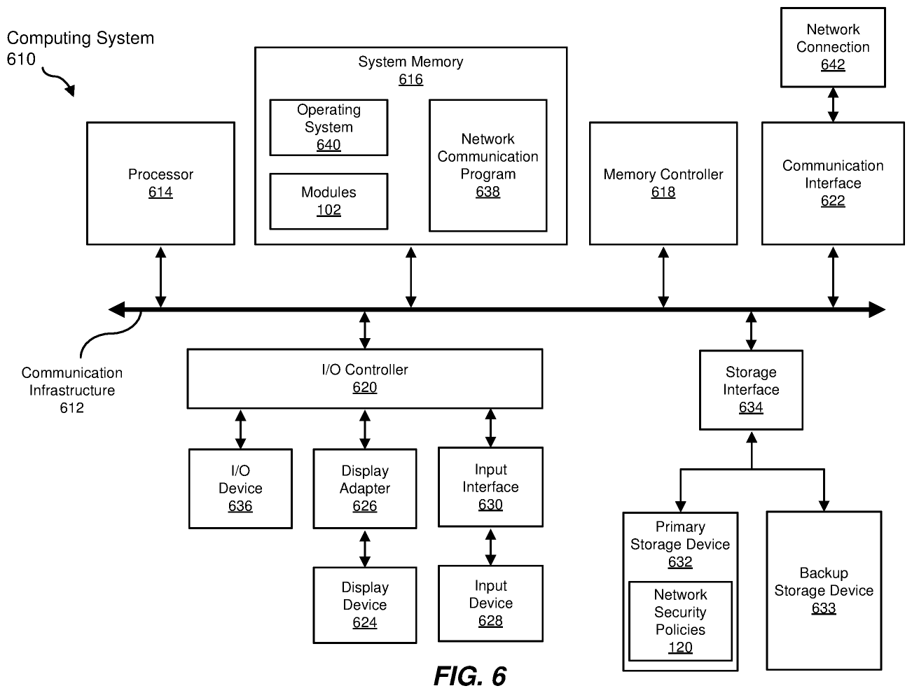

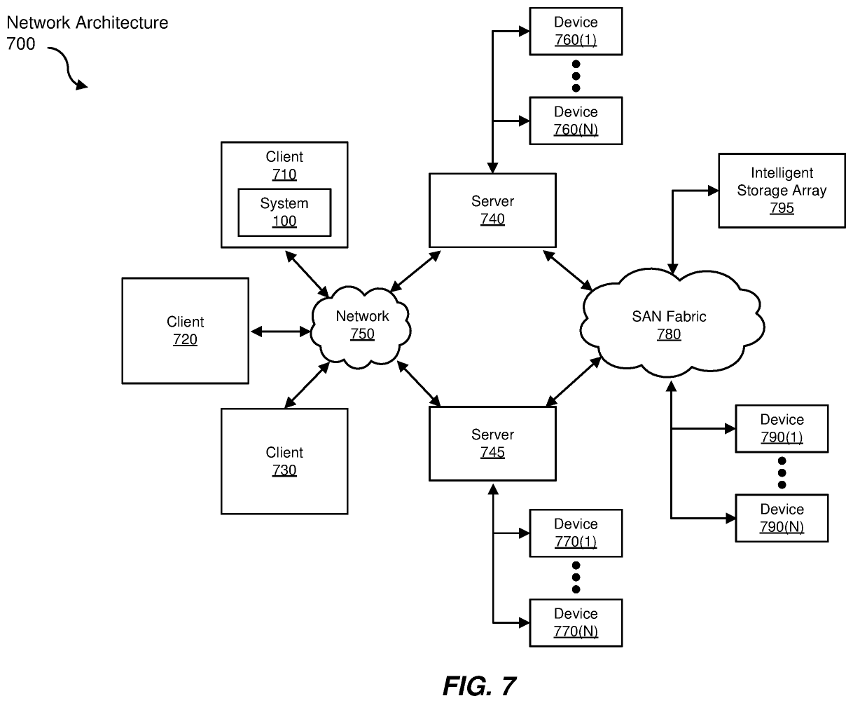

The following will provide, with reference to FIGS. 1-2, detailed descriptions of example systems for split network tunneling based on traffic inspection. Detailed descriptions of corresponding computer-implemented methods will also be provided in connection with FIG. 3. Detailed descriptions of split tunnel architectures are provided in connection with FIGS. 4-5. In addition, detailed descriptions of an example computing system and network architecture capable of implementing one or more of the embodiments described herein will be provided in connection with FIGS. 6 and 7, respectively.

FIG. 1 is a block diagram of an example system 100 for split network tunneling based on traffic inspection. As illustrated in this figure, example system 100 may include one or more modules 102 for performing one or more tasks. As will be explained in greater detail below, modules 102 may include a receiving module 104, a parser module 106, an inspection module 108, a direct transmission module 110, a secure transmission module 112, and a security action module 114. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate split network tunneling based on traffic inspection. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include one or more network security policies, such as network security policies 120. Network security policies 120 generally represents any type or form of rule, condition, constraint, or the like that may be used to make determinations regarding device traffic transmissions. In one example, network security policies 120 may include rules outlining data access, web browsing access, use of passwords and encryption, email attachments and the like.

Example system 100 in FIG. 1 may be implemented in a variety of ways. For example, all or a portion of example system 100 may represent portions of example system 200 in FIG. 2. As shown in FIG. 2, system 200 may include a computing device 206 in communication with a remote server 208 and/or a destination host 210 via a network 204. In one example, all or a portion of the functionality of modules 102 may be performed by computing device 206, remote server 208, destination host 210 and/or any other suitable computing system. As will be described in greater detail below, one or more of modules 102 from FIG. 1 may, when executed by at least one processor of computing device 206, remote server 208, and/or destination host 210, enable computing device 206, remote server 208, and/or destination host 210 to provide split network tunneling based on traffic inspection. For example, and as will be described in greater detail below, one or more of modules 102 may cause computing device 206, remote server 208, and/or destination host 210 to (i) direct network traffic to a network client of the computing device by receiving module 104, (ii) perform an inspection of the network traffic by the network client by inspection module 108 of network traffic parsed by parser module 106, (iii) categorize the network traffic based on the inspection by inspection module 108, and (iv) in response to categorizing the network traffic, perform a security action to protect the computing device from computer malware.

Computing device 206 generally represents any type or form of computing device capable of reading computer-executable instructions. Examples of computing device 206 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Remote server 208 generally represents any type or form of computing device that is capable reading computer-executable instructions. Remote server 208, such as a remote VPN server (also known as a VPN provider), may be coupled to the computing device 206 over a secure encrypted connection, such as a VPN tunnel. Additional examples of remote server 208 include, without limitation, security servers, application servers, web servers, storage servers, and/or database servers configured to run certain software applications and/or provide various security, web, storage, and/or database services. Although illustrated as a single entity in FIG. 2, remote server 208 may include and/or represent a plurality of servers that work and/or operate in conjunction with one another.

Destination host 210 generally represents any type or form of computing device that is capable reading computer-executable instructions. Destination host 210 does not require any type of secure channel and may be accessed by computing devices without any encryption or additional security measures. Additional examples of destination host 210 include, without limitation, security servers, application servers, web servers, storage servers, and/or database servers configured to run certain software applications and/or provide various security, web, storage, and/or database services. Although illustrated as a single entity in FIG. 2, destination host 210 may include and/or represent a plurality of servers that work and/or operate in conjunction with one another.

Network 204 generally represents any medium or architecture capable of facilitating communication or data transfer. In one example, network 204 may facilitate communication between computing device 206, remote server 208, and/or destination host 210. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for split network tunneling based on traffic inspection. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may direct network traffic for a computing device 206 to a network client executing on the computing device 206. In some embodiments, a network client may be a VPN client. In some embodiments, the network client may be an implementation of a VPN interface provided by system software development kits (SDKs) and may include protocol parsers, which may parse data from different layers of a network packet of the device traffic. For example, receiving module 104 may, as part of computing device 206 in FIG. 2, direct network traffic for computing device 206 to a network client of the computing device 206. In some examples, all network traffic for computing device 206 may be directed or redirected to a network client of the computing device 206. The network client may provide split tunneling capabilities, allowing some of the network traffic to directly access destination hosts or the Internet, while other traffic may be routed through a remote sever for additional security.

At step 304, one or more of the systems described herein provide a network client that may perform an inspection of the network traffic. For example, receiving module 104 may, as part of system 200 in FIG. 2, transmit the network traffic to parser module 106. Parser module 106 may include multiple different parsers. Parser module 106 may select a parser based on the network traffic and may parse the network traffic using the selected parser. Examples of parsers may include an Internet Protocol (IP) parser, a Transmission Control Protocol (TCP) parser, a Secure Sockets Layer (SSL) parser, a Domain Name System (DNS) parser, Hypertext Transfer Protocol (HTTP) parser, or any other type of parser used to process and parse network packets.

The systems described herein may perform step 304 in any suitable manner. For example, inspection module 108 may receive the parsed network traffic from parser module 106 and may apply one or more filters and/or security policies to the traffic. For example, inspection module 108 may include a web filter, a content filter, and a tunnel selector. The web filter may determine a reputation associated with a domain. For example, the inspection module 108 may extract a domain name from the parsed data and may use the domain name to obtain reputation data. The reputation data may be stored locally or on a remote computing device. The reputation data may be a numeric value of a given scale that indicates a positive or negative data associated with the domain name (e.g., number of incident reports, detection of malware on the domain, etc.). Similarly, the content filter may determine which content may require additional security (e.g., email, file repositories, etc.) and content that may be directly transmitted (e.g., streaming content request from a known content provider). The tunnel selector of the inspection module 108 may determine whether to transmit traffic through a secure tunnel to a remote server. The inspection module 108 may inspect the network traffic and proceed to step 306.

At step 306, the systems described herein may categorize the network traffic based on the inspection. For example, inspection module 108 may, as part of system 200 in FIG. 2, determine based on the inspection of the network traffic, that the network traffic requires additional security measures (e.g., email, file repositories, protected resources, etc.) or that the network traffic does not require additional security measures (e.g., requesting streaming content from a known content provider). In some examples, the network traffic categorization may require the inspection module 108 to obtain additional information associated with the network traffic. For example, the inspection module 108 may compare a domain to a list of known and cleared-as-safe websites, obtain reputation data associated with domains based on historic interaction data, or the like.

At step 308, in one or more of the systems described herein, the network client that may perform security action to protect the computing device from computer malware. For example, security action module 114 may, as part of system 200 in FIG. 2, receive data (e.g., categorization of the network traffic) from inspection module 108. The security action module 114 may determine, in response to the data received, that the traffic should be blocked, transmitted through direct transmission to a destination host, or through secure transmission to a remote server, as will be further discussed herein.

The systems described herein may perform step 308 in any suitable manner. For example, security action module 114 may receive data from inspection module 108. If the security action module 114 determines to block access to an external resource, such as a destination host, remote server, or the like, the security action module 114 may communicate with a proxy socket of a network client executing on the computing device to block access to the resource and to transmit a message to the user indicating that access to the external resource has been block. The message may include an indication of the reasons for blocking access (e.g., low reputation score of a website, historical data indicating potential high security risk, or the like).

In some examples, the security action module 114 may determine to transmit the traffic based on data received from the inspection module 108. The security action module 114 may determine to directly transmit the traffic to a designated destination host. The security action module may transmit the traffic to direct transmission module 110, which may determine a type of connection to establish with the destination host (e.g., transmission control protocol (TCP), User Datagram Protocol (UDP), etc.) and transmit the traffic to the destination host accordingly. The direct transmission module 110 may also receive response data from the destination host and transmit the data to a system network stack of the computing device for further processing.

In some examples, the security action module 114 may determine to securely transmit the traffic to a remote server. The security action module 114 may transmit the traffic to secure transmission module 112, which may encrypt and/or encapsulate the traffic. The secure transmission module 112 may establish a secure tunnel to the remote server and may transmit the encrypted/encapsulated traffic to the remote server. The secure transmission module 112 may also receive response data from the remote server, decrypt and/or de-encapsulate the response data, and transmit the data to a system network stack of the computing device for further processing.

FIG. 4 is a block diagram of an example architecture 400 for split tunneling on a computing device. As illustrated in this figure, example system 400 may include system network stack 402, routing table 404, destination host 406, VPN client 408, and remote VPN server 420. VPN client 408 may include outbound component 410, inbound component 412, and remote VPN tunnel connections 414. Remote VPN tunnel connections 414 may include tunnel transmit 416 and tunnel receive 418.

As illustrated in FIG. 4, example system 400 may include system network stack 402. System network stack 402 may be responsible for network protocols used in a communication network. System network stack 402 may be used to accommodate different network architectures for incoming and outgoing network traffic for a computing device. System network stack 402 may direct outbound network traffic of a computing device to routing table 404 of the operating system of the computing device. Routing table 404 may include a set of rules used to determine where data packets traveling over an internet protocol (IP) network will be directed. Routing table 404 may be used to split the traffic (e.g., redirect portions of the traffic) based on its destination IP address.

As depicted in FIG. 4, routing table 404 may determine the route of traffic before the traffic reaches VPN client 408. In some examples, routing table 404 may route a portion of the traffic directly to destination host 406, thereby bypassing VPN client 408. The traffic that bypasses VPN client 408 also bypasses security measures provided by VPN client 408. Destination host 406 may be any server or computing device that may be directly accessed by computing devices without encryption or other security measures. Examples of a destination host 406 may include a webpage, server, or the like.

Routing table 404 may route a portion of the traffic to VPN client 408. VPN client 408 may include outbound component 410 and inbound component 412. Outbound component 410 may receive device traffic routed by routing table 404 to VPN client 408. Outbound component 410 may transmit the received outbound device traffic to remote VPN tunnel connections 414. Remote VPN tunnel connections 414 may transmit the device traffic to remote VPN server 420 using tunnel transmit 416. Tunnel transmit 416 may be a component that establishes a secure tunnel with remote VPN server 420, encrypts the device traffic, and transmits the encrypted device traffic to remote VPN server 420 using the secure channel. Remote VPN server 420 may receive the device traffic over the encrypted tunnel, decrypt the traffic, and process the traffic accordingly. In some embodiments, remote VPN server 420 may communicate with one or more destination hosts 406, as specified by the device traffic.

In some examples, remote VPN server 420 may receive a response from destination host 406. Remote VPN server 420 may communicate with VPN client 408 via remote VPN tunnel connection 414. Tunnel receive 418 may communicate with remote VPN server 420 to establish a secure tunnel. Tunnel receive 418 may receive an encrypted response packet from remote VPN server 420 and may decrypt the response packet. The response packet may be routed to inbound component 412, which may transmit the response packet to system network stack 402 for processing.

FIG. 5 is a block diagram of an example architecture 500 for split network tunneling based on traffic inspection. As illustrated in this figure, example system 500 may include system network stack 502, network client 504, destination host 530, and remote server 532. network client 504 may include L3 stack 506, L4 stack 512, direct socket 522, and secure socket 524. L3 stack 506 may include an outbound component 508 and an inbound component 510. L4 stack 512 may include inspection checkpoint 514 and a proxy socket 516. Inspection checkpoint 514 may include parser module 106 and inspection module 108. Proxy socket 516 may include inspection checkpoint 514 and proxy connect 518.

As illustrated in FIG. 5, example system 500 may include system network stack 502. Similar to system network stack 402, system network stack 502 may be responsible for network protocols used in a communication network. System network stack 502 may be used to accommodate different network architectures for incoming and outgoing network traffic for a computing device. System network stack 502 may direct outbound network traffic of a computing device to L3 stack 506 of the operating system of the computing device. The outbound network traffic may be received by outbound component 508, which may manage and coordinate receiving traffic and transmitting the traffic to L4 stack 512. The device traffic may be received at inspection checkpoint 514.

After inspection by inspection module 108, the device traffic may be transmitted to proxy connect 518. Proxy connect may determine at channel determination 520, based on data from a tunnel selector of the inspection module 108, which channel (e.g., channel type, channel and destination to transmit the traffic. For example, if the traffic requires additional security, proxy connect 518 may transmit the device traffic to secure socket 524, which may establish a secure tunnel with remote server 532 and transmit the traffic accordingly. Secure socket 524 may manage any data received from remote server 532. Secure socket 524 may receive response traffic from remote server 532, decrypt or de-encapsulate the traffic, and transmit the response through proxy socket 516 to inbound component 510 of L3 stack 506 and to the system network stack 502. If the traffic does not require additional security, the traffic may be transmitted to direct socket 522, which may transmit the traffic directly to a designated destination host 530. Direct socket 522 may manage any data received from destination host 530 and transmit the response through proxy socket 516 to inbound component 510 of L3 stack 506 and to the system network stack 502. Although FIG. 5 is discussed in terms of a single direct socket 522 and a single secure socket 524, the systems and methods described herein may be capable of handling multiple directs sockets 522 and multiple secure sockets 524, enabling the network client 504 to manage multiple channels for traffic that is received and processed by the computing device. For example, the network client 504 may provide multiple secure channels, which may be different types of secure channels, and multiple direct channels, which may also be different types of secure channels, for a computing device. In some examples, the secure channels may include middlebox channels, VPN secure tunnels, and the like. A middlebox may be a component that scans for malware along an encrypted channel

The network traffic may be parsed by parser module 106. Parser module 106 may include different types of parsers. For example, parser module 106 may include an IP parser, a TCP parser, SSL parser, a DNS parser, a HTTP parser, or any other type of parser use to process network packets. The parser module 106 may inspect the traffic to determine the type of network packet received and to select a parser to parse the traffic.

The parsed traffic may be transmitted to inspection module 108. Inspection module 108 may include different types of filters, proxies, and/or selectors. For example, inspection module 108 may include a web filter, content filter, DNS proxy, tunnel selector, and the like. The web filter may include rules and policies to identify risky or unsafe websites. In some embodiments, at inspection checkpoint 514, the parser module 106 may determine that the network traffic is a DNS request. The parsed data may be transmitted to the inspection module 108. A web filter of the inspection module 108 obtain a domain name extracted by the parser module 106 from the network traffic and may determine a reputation of the domain name. In some examples, the reputation data may be obtained by transmitted the domain name to a reputation server and receive reputation data associated with the domain name. For example, the reputation data may be a numeric score. The numeric score may indicate positive or negative reputation of the domain name. A negative reputation may indicate that the domain is untrustworthy or is associated with malware or otherwise fails a security metric. In some embodiments, a security action may be performed in response to determining a reputation of the domain name. For example, at access determination 526, if the domain name reputation is negative (e.g., is below a designated threshold value), the security action performed by the network client 504 may include proxy socket 516 blocking access 528 to a domain of the domain name. If the domain name reputation is positive, the security action may include proxy socket 516 allowing access to the domain of the domain name. Proxy socket 516 may determine to utilize direct socket 522 to access destination host 530. Proxy socket 516 may determine to utilize secure socket 524 to connect to remote server 532, which may communicate with destination host 530.

In some examples, the proxy socket 516 may receive an indication from remote server 532 that the remote server 532 has low bandwidth. The proxy socket 516 may determine to re-evaluate the traffic and load balance some of the traffic to a different remote server 532 or determine whether the data can be transmitted to direct socket 522 for direct transmission to a destination host 530.

In another example, the inspection module 108 may determine that the network traffic includes an HTTP request. In some embodiments, the parser module 106 may parse the network traffic using an HTTP parser and may determine that the HTTP request is for a protected resource of a remote server 532. The protected resource may be a file, internal webpage, or other resource only accessible on the remote server 532. A tunnel selector of inspection module 108 may determine, at channel determination 520, to perform a security action in response to determining the network traffic includes an HTTP request for the protected resource. The security action may include determining, at channel determination 520, that the network traffic is to be transmitted over one or more secure tunnels or channels by secure socket 524 to one or more remote server 532. For example, secure socket 524 may establish a secure tunnel to remote server 532, encrypt and/or encapsulate the HTTP request for the protected resource, and may transmit the request to remote server 532.

As explained above, by providing split network tunneling based on traffic inspection, a consolidated network client may enable traffic inspection of all network traffic for a computing device while providing the benefits of split tunneling device traffic, namely providing direct internet access or secure VPN connections based on user needs or dynamic policies. Traditional split tunneling systems may utilize a routing table of the operating system to split the traffic based on its destination IP address before the traffic reaches a VPN client. Traffic that bypasses the VPN, based on routing determined by the routing table, will also bypass any traffic inspection provided by the VPN infrastructure. The systems and methods described herein that provide split network tunneling based on traffic inspection may improve the security of a computing device by ensuring that the network client inspects device traffic. Appropriate security actions may be performed (e.g., blocking the traffic, permitting transmission of traffic, etc.) based on the inspection. The traffic determined to have access may be routed efficiently based on dynamic network security polices, either through direct transmission to a destination host or through secure transmission through a secure tunnel to a remote server. Additionally, the network client may also ensure compliance with certain regulations. For example, content streaming services may want to ban tunneled access to resources under geo-protected copyright. A consolidated network client may enable inspection of traffic and application of security checks by the network client then direct Internet access for such resources.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 coupled to I/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to I/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional I/O devices. For example, example computing system 610 may include I/O device 636. In this example, I/O device 636 may include and/or represent a user interface that facilitates human interaction with computing system 610. Examples of I/O device 636 include, without limitation, a computer mouse, a keyboard, a monitor, a printer, a modem, a camera, a scanner, a microphone, a touchscreen device, variations or combinations of one or more of the same, and/or any other I/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, network security policies 120 from FIG. 1 may be stored and/or loaded in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the instant disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for split network tunneling based on traffic inspection.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the computer-readable media used to carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, the systems and methods described herein may improve the functioning of computing devices by redirecting network traffic of a computing device to a network client (e.g., a VPN client) where the network traffic may be inspected. These systems and methods may also improve the fields of malware protection by efficiency of network traffic by traffic of a computing device to be inspected and security policies applied to vulnerable network traffic. Thus, the disclosed systems and methods may provide additional asset protection for common targets of malware by inspecting previously unsecure network traffic to identify malware. A further benefit of the systems and methods described herein may be an improvement in a user experience due to automated redirection of network traffic through a network client, rather than having to determine whether to use a VPN client for certain resources.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for split network tunneling based on traffic inspection, at least a portion of the method being performed by a computing device comprising at least one processor, the method comprising:
directing, by the computing device, network traffic to a network client of the computing device;
performing, by the network client, an inspection of the network traffic;
categorizing the network traffic based on the inspection; and
in response to categorizing the network traffic, performing a security action to protect the computing device from computer malware.

2. The computer-implemented method of claim 1, wherein performing the inspection of the network traffic comprises determining that the network traffic is a domain name system (DNS) request.

3. The computer-implemented method of claim 2, further comprising:
parsing the network traffic;
extracting a domain name from the network traffic;
determining a reputation of the domain name; and
in response to determining the reputation of the domain name, performing the security action, wherein the security action comprises one of blocking access to a domain of the domain name and allowing access to the domain of the domain name.

4. The computer-implemented method of claim 1, wherein performing the inspection of the network traffic comprises determining that the network traffic is a hypertext transfer protocol (HTTP) request.

5. The computer-implemented method of claim 4, further comprising:
parsing the network traffic;
determining that the HTTP request is for a protected resource of a remote server; and
performing the security action, wherein the security action comprises transmitting the network traffic over a secure tunnel to the remote server.

6. The computer-implemented method of claim 1, wherein the security action comprises at least one of:
blocking transmission of the network traffic;
transmitting the network traffic directly to a destination host; and
transmitting the network traffic through a secure tunnel connection to a remote server.

7. The computer-implemented method of claim 6, further comprising:
establishing a secure channel to a designated server; and
transmitting a portion of the network traffic to the designated server using the secure channel.

8. The computer-implemented method of claim 6, wherein the secure tunnel connection is at least one of:
a transport layer security (TLS) tunnel;
a datagram TLS (DTLS) tunnel;
an Internet Protocol Security (IPsec) tunnel; and
an OpenVPN tunnel.

9. The computer-implemented method of claim 6, wherein transmitting the network traffic directly to the destination host further comprises:
transmitting a payload of a packet of the network traffic directly to the destination host;
receiving a response from the destination host;
embedding the response in a response packet; and
transmitting the response packet to the network client.

10. The computer-implemented method of claim 1, further comprising:
logging the network traffic and the security action;
correlating the network traffic and the security action; and
generating a policy for the inspection of the network traffic based at least in part on correlations of the network traffic and the security action.

11. A system for split network tunneling based on traffic inspection, the system comprising:
a computing device comprising at least one physical processor; and
physical memory comprising computer-executable instructions that, when executed by the at least one physical processor, cause the computing device to:
direct network traffic to a network client of the computing device;
perform, by the network client, an inspection of the network traffic;
categorize the network traffic based on the inspection; and
in response to categorizing the network traffic, perform a security action to protect the computing device from computer malware.

12. The system of claim 11, wherein, to perform the inspection of the network traffic, the computer-executable instructions further cause the one or more computing devices to determine that the network traffic is a domain name system (DNS) request.

13. The system of claim 12, wherein the computer-executable instructions further cause the computing device to:
parse the network traffic;
extract a domain name from the network traffic;
determine a reputation of the domain name; and
in response to a determination of the reputation of the domain name, perform the security action, wherein the security action comprises one of blocking access to a domain of the domain name and allowing access to the domain of the domain name.

14. The system of claim 11, wherein, to perform the inspection of the network traffic, the computer-executable instructions further cause the computing device to determine that the network traffic is a hypertext transfer protocol (HTTP) request.

15. The system of claim 14, wherein the computer-executable instructions further cause the one or more computing devices to:
parse the network traffic;
determine that the HTTP request is for a protected resource of a remote server; and
perform the security action, wherein the security action comprises transmitting the network traffic over a secure tunnel to the remote server.

16. The system of claim 11, wherein the security action comprises at least one of:
block transmission of the network traffic;
transmit the network traffic directly to a destination host; and
transmit the network traffic through a secure tunnel connection to a remote server.

17. The system of claim 16, wherein the secure tunnel connection is at least one of:
a transport layer security (TLS) tunnel;
a datagram TLS (DTLS) tunnel;
an Internet Protocol Security (IPsec) tunnel; and
an OpenVPN tunnel.

18. The system of claim 16, wherein, to transmit the network traffic directly to a destination host, the computer-executable instructions further cause the computing device to:
transmit a payload of a packet of the network traffic directly to the destination host;
receive a response from the destination host;
embed the response in a response packet; and
transmit the response packet to the network client.

19. The system of claim 11, wherein the computer-executable instructions further cause the one or more computing devices to:
log the network traffic and the security action;
correlate the network traffic and the security action; and
generate a policy for the inspection of the network traffic based at least in part on correlations of the network traffic and the security action.

20. A non-transitory computer-readable medium comprising one or more computer-executable instructions that, when executed by at least one processor of a computing device, cause the computing device to:
direct network traffic to a network client of the computing device;
perform, by the network client, an inspection of the network traffic;
categorize the network traffic based on the inspection; and
in response to categorizing the network traffic, perform a security action to protect the computing device from computer malware.
